(19) United States
(12) Patent Application Publication
(10) Pub. No.: US 2015/0306984 A1
(43) Pub. Date: Oct. 29, 2015

(54) VEHICLE SEAT

(71) Applicant: JOHNSON CONTROLS COMPONENTS GMBH & CO., KG, Kaiserslautern (DE)

(72) Inventors: Thomas DILL, Heiligenmoschel (DE); Wolfgang PLUTA, Heiligenmoschel (DE); Heinrich HAMMANN, Teschenmoschel (DE); Viktor ENNS, Kaiserslautern (DE)

(73) Assignee: Johnson Controls Components GmbH & Co. KG, Kaiserslautern (DE)

(21) Appl. No.: 14/647,530

(22) PCT Filed: Nov. 27, 2013
(86) PCT No.: PCT/EP2013/074846

§ 371 Date: May 27, 2015

(30) Foreign Application Priority Data
Nov. 30, 2012 (DE) 10 2012 023 781.2
Feb. 27, 2013 (DE) 102013 003 788.3

(51) Int. Cl. B60N 2/22; B60R 22/26; B60R 22/18

(52) U.S. Cl. CPC B60N 2/22; B60R 22/18; B60R 22/26; B60R 2022/1818; B60R 2022/266; B60N 2205/35

(57) ABSTRACT

A vehicle seat (1) includes a seat segment (14) with a first seat (11) including a first backrest (21) that can be pivoted about a pivot axis (A), and a second seat (12) including a second backrest (22) that can be pivoted about the pivot axis (A). A coupling (8, 9) couples the first backrest (21) to the second backrest (22) to be pivotable together when the backrests (21, 22) are coupled together. The second backrest (22) is pivotable independently of the first backrest (21) when the backrests (21, 22) are uncoupled. A belt outlet point for seat belt webbing, which is associated with the second seat (12), runs in a vertical direction in an approximately direct line over a longitudinal side piece (41) and a mounting (5) for the first backrest (21) of the first seat (11).

### CROSS REFERENCE TO RELATED APPLICATIONS

This application is a United States National Phase Application of International Application PCT/EP2013074846 filed Nov. 27, 2013 and claims the benefit of priority under 35 U.S.C. §119 of German Patent Application DE 10 2012 023781.2 filed on Nov. 30, 2012 and DE 10 2013 003 788.3 filed Feb. 27, 2013, the entire contents of which are incorporated herein by reference.

### FIELD OF THE INVENTION

The invention relates to a vehicle seat having a seat segment which comprises a first seating position, with a first backrest which is pivotable about a pivot axis, and a second seating position, with a second backrest which is pivotable about the pivot axis.

### BACKGROUND OF THE INVENTION

DE 10 2007 011 874 A1 has disclosed a generic vehicle seat. The vehicle seat, which is designed as a rear seat, comprises two seat segments, wherein one of the seat segments comprises one seating position and the other seat segment comprises two seating positions. The two seat segments are arranged adjacent to one another and are displaceable in the direction of travel independently of one another by means of longitudinal adjusters.

A pivotable backrest is attached to the seat segment that comprises one seating position. The seat segment which comprises two seating positions has attached to it two backrests which are arranged adjacent to one another and which are pivotable about the same pivot axis relative to the seat segment.

EP 2 103 480 A2 has disclosed a vehicle seat having three seating positions. The vehicle seat comprises two seat segments, wherein one of the seat segments comprises a seating position with a pivotable backrest. The other seat segment comprises two seating positions, wherein said two seating positions have a common pivotable backrest.

### SUMMARY OF THE INVENTION

The problem addressed by the invention is that of improving a vehicle seat of the type mentioned in the introduction, in particular that of, with a simplified construction, attaching a three-point seatbelt to the middle seat segment.

A generic vehicle seat has a seat segment which has a first seating position, with a first backrest which is pivotable about a pivot axis, and a second seating position, with a second backrest which is pivotable about the pivot axis.

According to the invention, the vehicle seat has coupling means for the coupling of the first backrest to the second backrest, wherein, when the backrests are coupled to one another, the second backrest is pivotable together with the first backrest, and wherein, when the backrests are decoupled, the second backrest is pivotable independently of the first backrest, and a seatbelt outlet point, assigned to the second seating position, for a seatbelt web is arranged, as viewed in a vertical direction, approximately in a direct line, that is to say without lateral offset, above a longitudinal member and a fitting of the first backrest of the first seating position. Said assignment is to be understood to mean that the seatbelt web and the seatbelt outlet point are provided for use by an occupant seated in the second seating position.

In this way, a moment that is generated in the event of a crash is introduced via the seatbelt outlet point into the first backrest of the first seating position, and is dissipated directly via the longitudinal member and the fitting of the first backrest of the first seating position.

In this case, no significant moment is transmitted to the backrest of the second seating position. Furthermore, the moment that is generated is dissipated almost entirely via said longitudinal member and said fitting. Further components of the first backrest of the first seating position, in particular a backrest panel, are subjected to only insignificant load.

The first backrest is preferably connected by means of the fitting to a transverse tube which extends at least approximately over the entire width of the seat segment. A moment that is generated in the event of a crash is then transmitted from the fitting into the transverse tube and dissipated by the latter, for example directly into the vehicle structure or into a longitudinal adjuster.

It is preferably the case that the transverse tube runs parallel to the pivot axis and is arranged below the pivot axis. A moment that is generated in the event of a crash is then transmitted from the fitting initially vertically downward into the transverse tube and is then dissipated to the sides by said transverse tube.

In one advantageous refinement of the invention, a seatbelt diverting hoop is arranged close to an upper end, remote from the pivot axis, of the first backrest and defines the seatbelt outlet point for the seatbelt web of the second seating position.

In one advantageous refinement of the invention, a seatbelt mechanism assigned to the second seating position is fastened to the first backrest.

To facilitate assembly and to realize an increase in strength, the first backrest has a mounting panel to which the seatbelt mechanism assigned to the second seating position is connected, preferably screwed. In this case, the seatbelt mechanism is preferably accommodated in positively locking fashion by the mounting panel.

It is preferably the case that the mounting panel is arranged close to the pivot axis and is connected to the longitudinal member and to a lower transverse member of the first backrest. In particular, the mounting panel is preferably welded to the longitudinal member and/or to the lower transverse member.

In one advantageous refinement of the invention, the seatbelt mechanism assigned to the second seating position is arranged close to the pivot axis.

In another advantageous refinement of the invention, the seatbelt mechanism assigned to the second seating position is arranged close to an upper end, remote from the pivot axis, of the first backrest.

The coupling means preferably comprise a pin, which is arranged on one of the two backrests, and a locking device, which is arranged on the other backrest and which interacts with the pin.

In this case, the locking device is advantageously arranged close to the upper end, remote from the pivot axis, of the backrest, in particular on the second backrest. In this case, the pin is arranged on the first backrest.

The seat segment comprises a seat part relative to which the first backrest and the second backrest are pivotable.

The vehicle seat also has a second seat segment which comprises a second seat part and a third backrest which is pivotable relative to said second seat part.

Below, the invention will be discussed in more detail on the basis of an advantageous exemplary embodiment illustrated in the figures. The invention is however not restricted to this exemplary embodiment. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective illustration of a vehicle seat without cushioning;

FIG. 2 is an exploded illustration of a backrest blank;

FIG. 3 is an exploded illustration of a backrest;

FIG. 4 is a view showing construction kit components of the longitudinal members; and

FIG. 5 is a horizontal sectional view through a backrest.

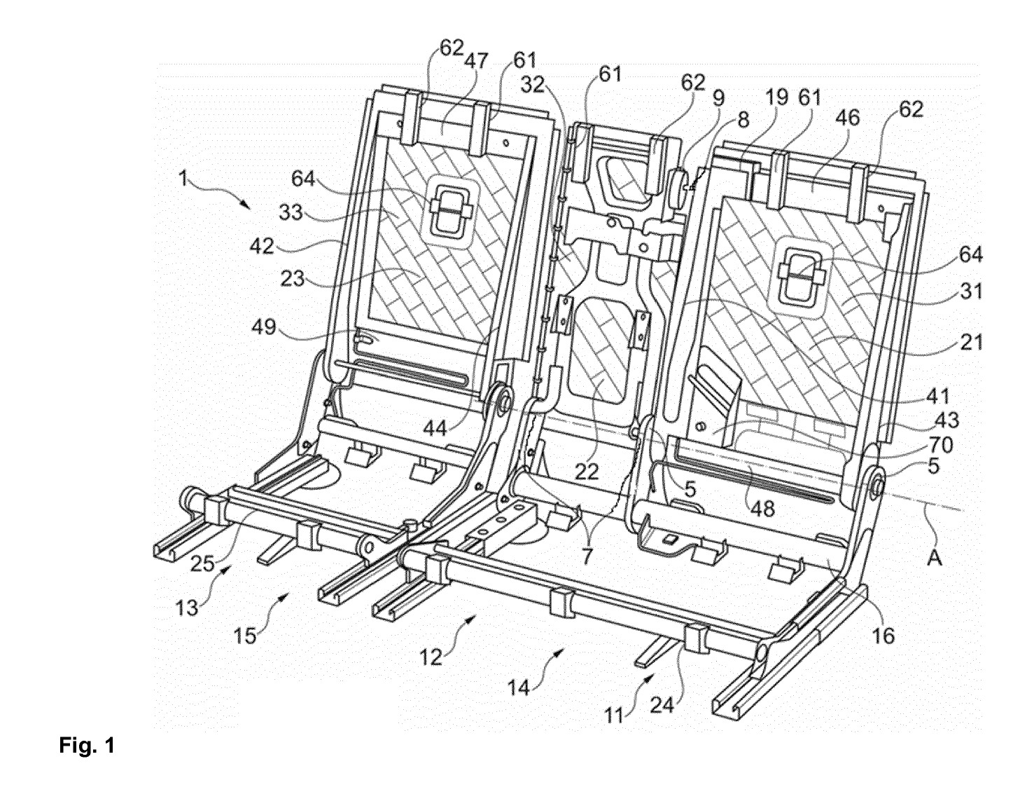

### DESCRIPTION OF THE PREFERRED EMBODIMENTS

A vehicle seat 1 is designed as a rear seat installation of a motor vehicle. The vehicle seat 1 comprises a first seat segment 14 with a first seat part 24 and a second seat segment 15 with a second seat part 25, which seat segments are connected to the vehicle structure of the motor vehicle so as to be longitudinally adjustable independently of one another by means of longitudinal adjusters.

The arrangement of the vehicle seat 1 within the vehicle and the normal direction of travel thereof define the directional designations used below. In this case, a direction oriented perpendicular to the ground is hereinafter referred to as vertical direction, and a direction perpendicular to the vertical direction and perpendicular to the direction of travel is hereinafter referred to as transverse direction. In the present case, the vertical direction also encompasses angles of up to 30° with respect to the vertical, and in particular, encompasses the orientation of a backrest of the vehicle seat 1 in an upright usage position when installed in the vehicle.

The first seat segment 14 accounts for approximately 60% of the total width of the vehicle seat 1, whereas the second seat segment 15 accounts for approximately 40% of said width. A first backrest 21 and a second backrest 22 are attached to the first seat part 24 so as to be pivotable about a pivot axis A, whereas a third backrest 23 is pivotably attached to the second seat part 25. The second backrest 22 is arranged in the transverse direction between the first backrest 21 and the third backrest 23. The pivot axis A runs horizontally in the transverse direction.

The first backrest 21 forms, with a part of the first seat part 24, a first seating position 11. The second backrest 22 forms, with a part of the first seat part 24, a second seating position 12. The third backrest 23 forms, with the second seat part 25, a third seating position 13. The first seating position 11 and the second seating position 12 are assigned to the first seat segment 14, and the third seating position 13 is assigned to the second seat segment 15.

The first backrest 21 comprises a first backrest panel 31 which is reinforced by means of a first right-hand longitudinal member 41, a first left-hand longitudinal member 43, a first upper transverse member 46, and a first lower transverse member 48. The second backrest 22 comprises a second backrest panel 32. The third backrest 23 comprises a third backrest panel 33 which is reinforced by means of a second right-hand longitudinal member 42, a second left-hand longitudinal member 44, a second upper transverse member 47 and a second lower transverse member 49. The first right-hand longitudinal member 41 of the first backrest 21 and the second left-hand longitudinal member 44 of the third backrest 23 each face toward the second backrest 22.

The second right-hand longitudinal member 42 is formed from a right-hand frame part 52. The second left-hand longitudinal member 44 is formed from a left-hand frame part 54. The right-hand frame part 52 and the left-hand frame part 54 are in this case of mirror-symmetrical design.

The first right-hand longitudinal member 41 is formed from a right-hand frame part 52 and a right-hand reinforcement part 51. The first left-hand longitudinal member 43 is formed from a left-hand frame part 54 and a left-hand reinforcement part 53. The right-hand reinforcement part 51 and the left-hand reinforcement part 53 are in this case of mirror-symmetrical design.

Thus, two identical right-hand frame parts 52 and two identical left-hand frame parts 54 are provided in the vehicle seat 1, specifically in each case in the first backrest 21 and in the third backrest 23.

From a manufacturing aspect, the mirror-symmetrical right-hand frame parts 52 and left-hand frame parts 54 can be produced using the same pressing tool. Likewise, the mirror-symmetrical right-hand reinforcement parts 51 and left-hand reinforcement parts 53 can be produced using the same pressing tool. Thus, only two pressing tools are required for producing the four longitudinal members 41, 42, 43, 44.

The first upper transverse member 46, the second upper transverse member 47 and the second lower transverse member 49 are each formed as identical profile parts 56. Thus, there are three identical profile parts 56 in the vehicle seat 1, specifically one in the first backrest 21 and two in the third backrest 23.

The first lower transverse member 48 is in the present case designed as a square tube and thus differs from the profile part 56.

Each of the backrests 21, 22, 23 furthermore comprises in each case one first headrest mount 61, one second headrest mount 62 and one top tether bracket 64, which are likewise in each case of identical design.

Furthermore, the first backrest panel 31 of the first backrest 21 and the third backrest panel 33 of the third backrest 23 are of identical design.

The seat parts 24, 25 and the backrests 21, 22, 23 are, in a known manner, provided with cushioning. The first backrest 21 and the third backrest 23 each account for approximately 40% of the total width of the vehicle seat 1, whereas the second backrest 22 accounts for approximately 20% of said width.

The first seat part 24 comprises a transverse tube 16 which runs in the transverse direction, parallel to the pivot axis A, and which extends approximately over the entire width of the first seat part 24 and thus also approximately over the entire width of the first seat segment 14.

The first backrest 21 is connected by means of two fittings 5 to the transverse tube 16 of the first seat part 24. The fittings 5 are in the present case of identical construction. Each fitting 5 has a first fitting part, which is fixedly connected to the first seat part 24, that is to say which is fixed with respect to the seat part, and a second fitting part which is fixedly connected to the first backrest 21, that is to say which is fixed with respect to the backrest, which fitting parts are pivotable relative to one another. The two fitting parts may, from a structural aspect, form a disk-shaped unit and be held together for example by way of a clasping ring.

In the present case, the fittings 5 are each in the form of locking fittings, that is to say the two fitting parts can be locked together by means of movable bolts. The bolts are moved into a locking position for example by way of a spring-loaded eccentric. By means of the fittings 5, the first backrest 21 can firstly be adjusted in terms of its inclination relative to the first seat part 24 into different usage positions, and can secondly be pivoted forward into a non-usage position.

The second backrest 22 is connected by means of two rotary bearings 7 to the transverse tube 16 of the first seat part 24. Close to the upper end, which faces away from the pivot axis A, of the second backrest 22 there is arranged a locking device 9 which interacts with a pin 8 provided on the first backrest 21.

When the locking device 9 is locked to the pin 8, the second backrest 22 is pivotable together with the first backrest 21 relative to the first seat part 24. When the locking device 9 is unlocked, the second backrest 22 can, independently of the first backrest 21, be pivoted forward relative to the first seat part 24 into the non-usage position.

Each of the three seating positions has a three-point seatbelt, wherein each three-point seatbelt comprises a seatbelt mechanism (not illustrated here). The seatbelt mechanisms of the first seating position 11 and of the third seating position 13 are each fastened to the vehicle structure.

The seatbelt mechanism of the second seating position 12 is fastened to the first backrest 21 of the first seating position 11. Thus, the seatbelt mechanism of the second seating position 12 is likewise situated in the first seat segment 14.

In the present case, the seatbelt mechanism of the second seating position 12 is arranged close to the pivot axis A and directly adjacent to the first right-hand longitudinal member 41 of the first backrest 21. A seatbelt web (not illustrated here) runs approximately parallel to the first right-hand longitudinal member 41 and parallel to the first backrest panel 31 from said seatbelt mechanism to a seatbelt diverting hoop 19 arranged close to the upper end, which is remote from the pivot axis A, of the first backrest 21 and thus also close to the pin 8.

The first backrest 21 has, for this purpose, a mounting panel 70 which accommodates the seatbelt mechanism (not illustrated) of the second seating position 12. The mounting panel 70 is arranged adjacent to the first right-hand longitudinal member 41 and above the pivot axis A. The mounting panel 70 is of substantially flat form and has a bend on the side remote from the first right-hand longitudinal member 41.

The mounting panel 70 lies against the first backrest panel 31. In the present case, the mounting panel 70 is connected, in the present case welded, to the first right-hand longitudinal member 41 and to the first lower transverse member 48.

In the present case, the seatbelt mechanism (not illustrated) of the second seating position 12 lies against the mounting panel 70 and is connected, in the present case screwed, thereto. For this purpose, in the present case, the mounting panel 70 has a protruding weld stud with external thread which projects through a fastening plate of the seatbelt mechanism and onto which there is then screwed a nut with internal thread.

The seatbelt diverting hoop 19 defines in this case a seatbelt outlet point for the seatbelt web of the second seating position 12. It is also conceivable for the seatbelt mechanism to be arranged close to the upper end, which faces away from the pivot axis A, of the first backrest 21 and close to the pin 8. In this case, the seatbelt diverting hoop 19 may be omitted if the seatbelt mechanism itself defines the seatbelt outlet point for the seatbelt web of the second seating position 12.

The seatbelt diverting hoop 19 is situated directly adjacent, in the transverse direction, to the first right-hand longitudinal member 41, which is situated directly adjacent to the associated fitting 5. The associated fitting 5, the right-hand longitudinal member 41 and the seatbelt diverting hoop 19 are thus situated approximately one above the other in the vertical direction and are offset relative to one another only slightly in the transverse direction.

When an occupant is seated in the second seating position 12 and uses the associated seatbelt, it is thus the case in the event of a crash that the seatbelt web pulls on the seatbelt diverting bracket 19 in a forward direction of travel, and thus exerts a moment on the first backrest 21 about the pivot axis A. Said moment is transmitted from the first right-hand longitudinal member 41 to the fitting 5 and is introduced into the latter. The fitting transmits the moment into the transverse tube 16, and from there the moment is introduced, in the present case via the longitudinal adjuster, into the vehicle structure.

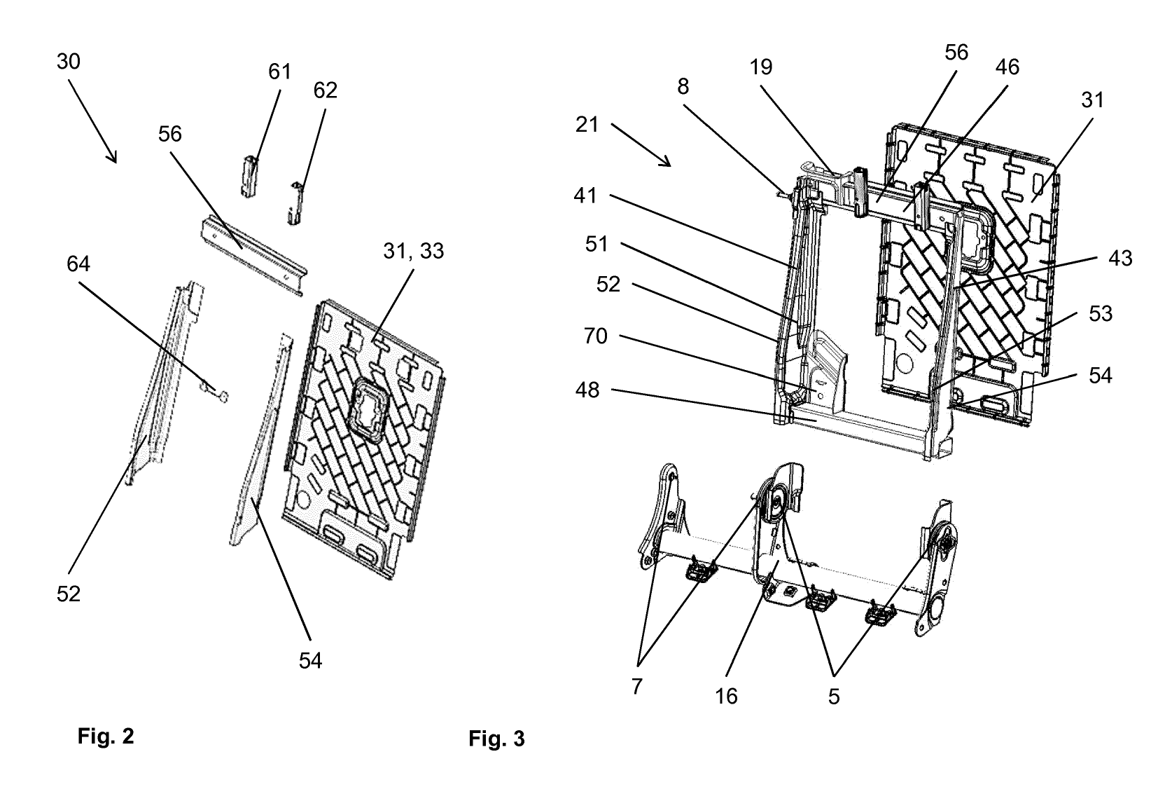

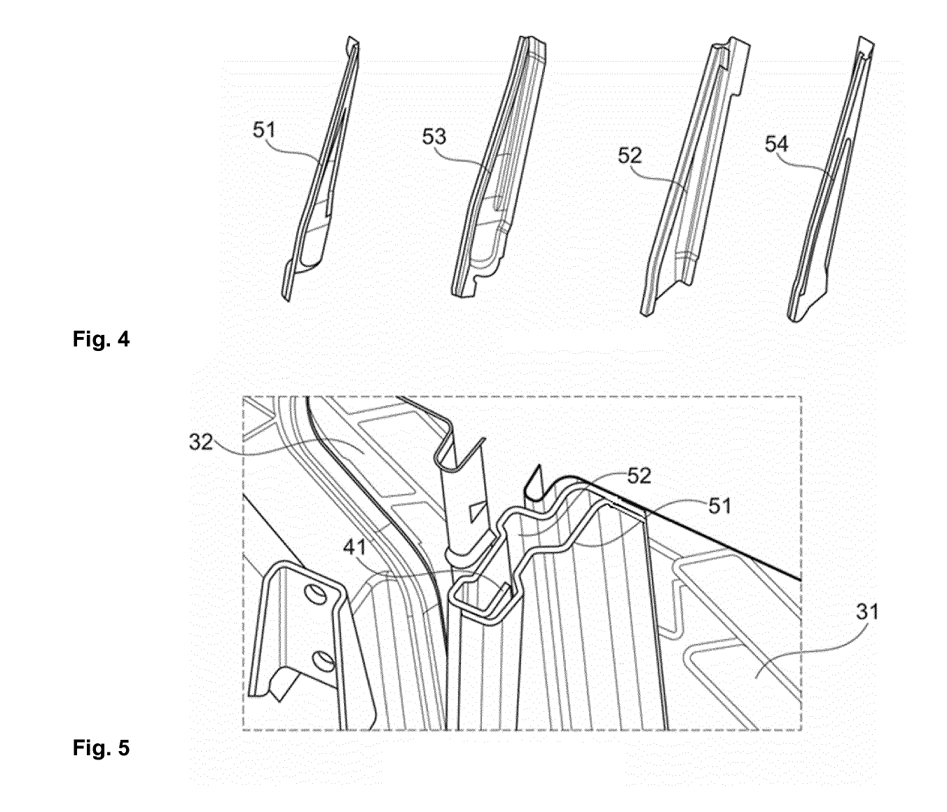

The first backrest 21 and the third backrest 23 are of substantially identical construction and each comprise a backrest panel 31 and 33 respectively, a right-hand frame part 52, a left-hand frame part 54, a profile part 56 as upper transverse member 46 and 47 respectively, and a first headrest mount 61, a second headrest mount 62 and a top tether bracket 64. A backrest blank 30 of said type is illustrated in FIG. 2.

The third backrest 23 additionally comprises a further profile part 56 as a second lower transverse member 49. The first backrest 21 additionally comprises the square tube as first lower transverse member 48, the reinforcement parts 51, 53, the seatbelt mechanism, the seatbelt diverting hoop 19, the mounting panel 70 and the pin 8.

The features disclosed in the above description, in the claims and in the drawings may be of importance both individually and in combination for the implementation of the invention in its various embodiments.

While specific embodiments of the invention have been shown and described in detail to illustrate the application of the principles of the invention, it will be understood that the invention may be embodied otherwise without departing from such principles.

1. A vehicle seat comprising:
a seat segment which comprises a first seating position, with a first backrest which is pivotable about a pivot axis, and a second seating position, with a second backrest which is pivotable about the pivot axis, the first backrest of the first seating position having a longitudinal member and a fitting;
a coupling means for the coupling of the first backrest to the second backrest, wherein, when the backrests are coupled to one another, the second backrest is pivotable together with the first backrest, and wherein, when the backrests are decoupled, the second backrest is pivotable independently of the first backrest; and
a seatbelt outlet point, assigned to the second seating position, for a seatbelt web, wherein the seatbelt outlet point is arranged, as viewed in a vertical direction, approximately in a direct line above the longitudinal member and the fitting of the first backrest of the first seating position.

2. The vehicle seat as claimed in claim 1, wherein the first backrest is connected by the fitting to a transverse tube which extends at least approximately over an entire width of the seat segment.

3. The vehicle seat as claimed in claim 2, wherein the transverse tube runs parallel to the pivot axis and is arranged below the pivot axis.

4. The vehicle seat as claimed in claim 1, further comprising a seatbelt diverting hoop arranged close to an upper end, remote from the pivot axis, of the first backrest and defines the seatbelt outlet point for the seatbelt web of the second seating position.

5. The vehicle seat as claimed in claim 1, further comprising a seatbelt mechanism assigned to the second seating position wherein the seatbelt mechanism is fastened to the first backrest.

6. The vehicle seat as claimed in claim 5, wherein the first backrest has a mounting panel to which the seatbelt mechanism assigned to the second seating position is fixedly connected.

7. The vehicle seat as claimed in claim 6, wherein the seatbelt mechanism is accommodated in positively locking fashion by the mounting panel.

8. The vehicle seat as claimed in claim 7, wherein the mounting panel is arranged close to the pivot axis.

9. The vehicle seat as claimed in claim 8, wherein the mounting panel is fixedly connected to the longitudinal member and/or to a lower transverse member of the first backrest.

10. The vehicle seat as claimed in claim 5, wherein the seatbelt mechanism assigned to the second seating position is arranged close to the pivot axis.

11. The vehicle seat as claimed in claim 5, wherein the seatbelt mechanism assigned to the second seating position is arranged close to an upper end, remote from the pivot axis, of the first backrest.

12. The vehicle seat as claimed in claim 1, wherein the coupling means comprises a pin, which is arranged on one of the backrests, and a locking device, which is arranged on the other backrest and which interacts with the pin.

13. The vehicle seat as claimed in claim 12, wherein the locking device is arranged close to the upper end, remote from the pivot axis, of the second backrest.

14. The vehicle seat as claimed in claim 1, wherein the seat segment comprises a seat part relative to which the first backrest and the second backrest are pivotable.

15. The vehicle seat as claimed in claim 1, wherein the vehicle seat further comprises a second seat segment which comprises a second seat part and a third backrest which is pivotable relative to said second seat part.

16. A vehicle seat comprising:
a seat segment comprising a first seating position with a first backrest, which is pivotable about a pivot axis, and a second seating position with a second backrest, which is pivotable about the pivot axis, the first backrest of the first seating position comprising a longitudinal member and a fitting;
a coupling arrangement coupling the first backrest to the second backrest and providing a coupled state with the backrests coupled to one another wherein the second backrest is pivotable together with the first backrest and providing a decoupled state wherein the second backrest is pivotable independently of the first backrest; and
a second seating position seatbelt outlet arranged above the longitudinal member and above the fitting of the first backrest.

17. The vehicle seat as claimed in claim 16, wherein the first backrest is connected by the fitting to a transverse tube which extends at least approximately over an entire width of the seat segment and which transverse tube runs approximately parallel to the pivot axis and is arranged below the pivot axis.

18. The vehicle seat as claimed in claim 16, further comprising a seatbelt diverting hoop arranged adjacent to an upper end, remote from the pivot axis, of the first backrest wherein the diverting hoop defines the seatbelt outlet point for the seatbelt web of the second seating position.

19. The vehicle seat as claimed in claim 16, further comprising a seatbelt mechanism assigned to the second seating position wherein the first backrest has a mounting panel, to which the seatbelt mechanism assigned to the second seating position, is fixed.

20. The vehicle seat as claimed in claim 16, wherein the coupling arrangement comprises a pin, arranged on one of the backrests, and a locking device, arranged on the other backrest, wherein the locking device interacts with the pin.
